(19) United States
(12) Patent Application Publication
(10) Pub. No.: US 2010/0203441 A1
(43) Pub. Date: Aug. 12, 2010

(54) ELECTROSTATIC IMAGE DEVELOPING TONER, ELECTROSTATIC IMAGE DEVELOPER, IMAGE FORMING METHOD, AND IMAGE FORMING APPARATUS

(75) Inventors: Rieko KATAOKA, Singapore (SG); Masahiro OKITA, Kanagawa (JP); Toshiyuki YANO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/556,172

(22) Filed: Sep. 9, 2009

(30) Foreign Application Priority Data
Feb. 12, 2009 (JP) 2009-029390

(51) Int. Cl. G03G 13/20; G03G 9/08; G03G 9/10; G03G 9/087; G03G 15/08

(52) U.S. Cl. 430/109.4; 430/111.1; 430/110.3; 430/124.1; 399/252

(57) ABSTRACT

An electrostatic image developing toner includes toner mother particles that contain a binder resin, a coloring agent, and a release agent; and an external additive that contains a zinc-containing particles, wherein the number of free zinc-containing particles in all toner particles is from about by number to about 1.0% by number, and the free zinc-containing particles have a number average particle size of from about 1.0 μm to about 3.0 μm and an average circularity of from about 0.2 to about 0.6.

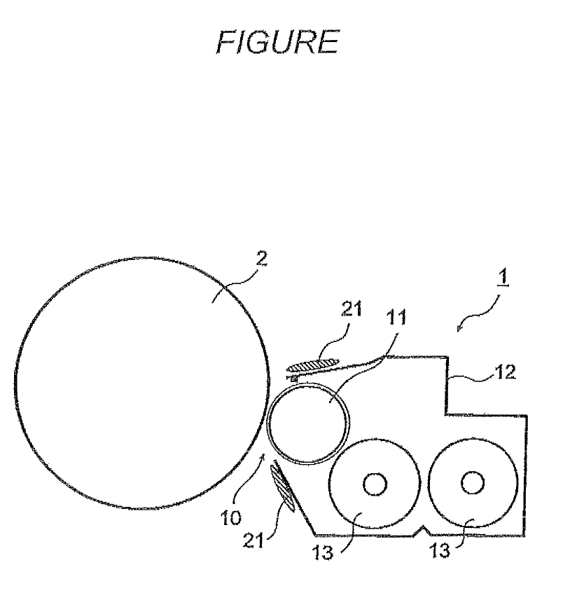

### CROSS-REFERENCE TO RELATED APPLICATIONS

This application is based on and claims priority under 35 USC 119 from Japanese Patent Application No. 2009-029390 filed on Feb. 12, 2009.

### BACKGROUND

1. Technical Field

This invention relates to an electrostatic image developing toner, an electrostatic image developer, an image forming method, and an image forming apparatus.

2. Related Art

Electrostatic image developing toners, developers or cartridges containing them can be exposed to high temperatures as high as 50° C. or even higher while transportation particularly during summer months. These products may be exposed to not only high temperatures but high humidities during overseas transportation near the equator. Although it is possible to transport the products in a specifically controlled environment, it is difficult to specify the equipment installation environment and the product storage condition. Therefore, it is required to guarantee high qualities of toners under possible high temperature and high humidity conditions.

In order to minimize energy consumption by copiers, printers, and so forth, a technique allowing for toner fixation in a fixing unit with lower energy has been desired. There has been a demand for an electrophotographic toner that is fixable at lower temperatures. Techniques using a crystalline resin as a binder resin of toners have been under study as a means for achieving low temperature fixability. A method using a crystalline resin as a toner binder resin is known.

Spherical toner particles have been used for electrophotographic image formation for their good transfer and regularity in shape in favor of obtaining non-granular appearing, high quality images.

### SUMMARY

According to an aspect of the invention, there is provided an electrostatic image developing toner including: toner mother particles that contain a binder resin, a coloring agent, and a release agent; and an external additive that contains a zinc-containing particles, wherein the number of free zinc-containing particles in all toner particles is from about 0.2% by number to about 1.0% by number, and the free zinc-containing particles have a number average particle size of from about 1.0 μm to about 3.0 μm and an average circularity of from about 0.2 to about 0.6.

### BRIEF DESCRIPTION OF THE DRAWINGS

Exemplary embodiment(s) of the present invention will be described in detail based on the following FIGURES, wherein:

FIGURE is a schematic, cross-section of a developing Unit,

wherein

1 denotes Developing unit, 2 denotes Image holding member, 10 denotes Opening, 11 denotes Developing roller, 12 denotes Developing housing, 13 denotes Agitator and 21 denotes Free toner.

### DETAILED DESCRIPTION

### (Electrostatic Image Developing Toner)

The toner according to the invention includes toner mother particles and an external additive. The toner mother particles contain a binder resin, a coloring agent, and a release agent. The external additive contains zinc-containing particles. The amount of free zinc-containing particles in all toner particles is from about 0.2% by number to about 1.0% by number. The free zinc-containirtg particles have a number average particle size of from about 1.0 μm to about 3.0 μm and an average circularity of about 0.2 to about 0.6. The toner of the invention will be described with reference to the accompanying drawing.

FIGURE is a schematic cross-section of an illustrative example of a developing unit.

A conventional developing machine 1 used in electrophotographic image forming apparatus, such as copiers and printers, generally has an electrostatic latent image holding member (simply “image holding member”) 2, such as a photoreceptor, and a developing housing 12 with a developing opening 10 proximate to the image holding member 2. The housing 12 contains a developer holding member, e.g., a developing roller 11 proximate to the opening 10 and a toner agitator 13. The machine 1 is configured such that a developer contained in the housing 12 is agitated by the agitator 13, held on the developing roller 11, conveyed to a development region corresponding to the opening 10 to visualize an electrostatic latent image on the image holding member 2.

The developing machine 1 having the structure described is associated with a technical problem that free toner particles (called toner cloud) 21 leak out of the housing 12 through the gap between the edge of the opening 10 and the developing roller 11 to contaminate the inside of the image forming apparatus.

Spherical toner particles remaining untransferred on the image holding member is difficult to remove because, for example, spherical toner particles, having no projections, tend to escape easily through between the image holding member and a scraper called a cleaning blade. If the pressing pressure (linear pressure) of the cleaning blade onto the image holding member is increased for sufficient removal of the residual spherical toner from the image holding member, the spherical toner itself is collapsed and tenaciously adheres to the image holding member (filming phenomenon). A filming phenomenon can lead to a streak defect. As used herein, the term “spherical” defines a particle having an average circularity of 0.96 to 1.00, the term “circularity” being defined later.

The fine alumina particles that are used in the toner of JP-A-2000-250251 are so hard and so abrasive as to not only remove the toner adhering to the photoreceptor but also scrape the photoreceptor. As a result, although using a toner having the alumina particles externally added thereto is effective in preventing toner filming that causes image defects such as streaks, the life of a photoreceptor is reduced due to the damage by the alumina particles.

With the toner disclosed in JP-A-2004-264602, although filming of toner mother particles or wax used in toner mother particles may be prevented, the filming problem of the resin particles per se is left unsolved. The problem essentially associated with the resin particles, i.e., collapse and deformation also needs a solution.

The present inventors have found that a toner containing about 0.2% by number to about 1.0% by number of free zinc-containing particles based on the total number of toner particles provides a solution to the problem of contaminating the inside of an image forming apparatus and the filming problem even after it is stored in a high temperature and high humidity environment.

With respect to storage in a high temperature and high humidity environment, it turned out that a toner undergoes changes in surface properties and the like, allowing an external additive adhering thereto to be embedded therein, which will invite reduction of toner flowability. It has now been revealed that the unfavorable phenomena accompanying the storage are eliminated by externally adding zinc-containing particles to toner particles such that the zinc-containing particles may be present in a free state in the toner in a specific amount. Specifically, because the zinc-containing external additive (i.e., zinc-containing particles) is present in a toner in a state weakly adhering to the toner particles or in a free state, it maintains a stable condition without undergoing deformation even under a high temperature high humidity condition. Thus, the zinc-containing external additive (zinc-containing particles) is hardly influenced by the change in surface properties of toner particles even after storage in a high temperature and high humidity environment and continues serving as a spacer. In addition, the zinc-containing external additive is prevented from being embedded in toner particles.

While poorly charged toner particles are to scatter and contaminate the inside of an image forming apparatus, when a toner contains a considerable amount of the zinc-containing particles in a free state (i.e., free zinc-containing particles) according to the invention, the toner adheres to the image holding member (e.g., photoreceptor) because of the positive chargeability, whereby the contamination of the apparatus is prevented, and the loose flying toner particles are developed on the background regions of the photoreceptor. Furthermore, the presence of a considerable amount of a zinc component in the toner makes it possible to prevent filming because, for one thing, the zinc component is uniformly applied to the surface of the photoreceptor and, for another, the zinc component forms a suitable dam along the edge of a cleaning blade to secure the cleaning function of the cleaning blade.

If the number of the free zinc-containing particles in the toner is less than 0.2% of the total number of the toner particles, development of the background regions of the image holding member (photoreceptor) will be insufficient, contamination inside the apparatus can occur, and the filming preventing effect will be insufficient. If the number of the free zinc-containing particles is more than 1.0% of the total number of the toner particles, the toner has unstable chargeability and tends to cause fogging of the image areas.

The number of the free zinc-containing particles in the toner particle is preferably about 0.3% by number to about 0.8% by nunber, more preferably about 0.3% by number to about 0.6% by number.

It is essential for the free zinc-containing particles to have a number average particle size of about 1.0 μm to about 3.0 μm. If the particle size is smaller than 1.0 μm, such fine zinc-containing particles will adhere easily to the surface of toner particles, making it difficult to control the amount of the zinc-containing particles present free. If the particle size exceeds 3.0 μm, such large particles can cause fogging or damage the image holding member.

The number average particle size of the free zinc-containing particles is preferably from about 1.2 μm to about 2.5 μm, more preferably from about 1.4 μm to about 2.0 μm.

The zinc-containing particles that are externally added to toner mother particles preferably have a number average particle size of about 0.1 μm to about 5 μm, more preferably about 0.8 μm to about 4.0 μm, even more preferably about 1.5 μm to about 3.5 μm. When the number average particle size of the zinc-containing particles to be externally added is within the range recited, it is easier to control the number average particle size of those particles that will be present in a free state in the toner within the range of from about 1.0 μm to about 3.0 μm.

The free zinc-containing particles have an average circularity of from about 0.2 to about 0.6. Particles with an average circularity less than 0.2 have an irregular shape and therefore easily adhere to the surface of toner mother particles due to the stress, such as caused by idling the developing machine. This results in decrease in amount of the free zinc-containing particles in the toner. On the other hand, particles with an average circularity more than 0.6 are nearly spherical. Nearly spherical, free zinc-containing particles adhering to an image holding member may escape from a cleaning blade, so that the inhibitory effect on filming will be insufficient.

The average circularity of the free zinc-containing particles is preferably from about 0.3 to about 0.55, more preferably from about 0.35 to about 0.50.

To satisfy the circularity requirement, it is preferred for the zinc-containing external additive (zinc-containing particles to be externally added to the toner particles) to have an average circularly of 0.2 to 0.6, more preferably 0.2 to 0.5.

The amount of the zinc-containing particles to be externally added to the toner mother particles is preferably about 0.1% by weight to about 0.5% by weight based on the total toner. When that amount is within the range recited, the amount of the tree zinc-containing particles in the toner is easily controllable.

The amount, number average particle size, and average circularity of free zinc-containing particles are determined as follows.

In a 150 ml glass beaker are added 100 ml of ion exchanged water, 0.2 ml of a sodium alkylbenzenesulfonate, and 0.2 g of a sample in the order described. A 2 cm long magnetic stir bar is put therein, and the mixture is stirred on a magnetic stirrer at 200 rpm for 3 minutes and then stirred using a spatula. The mixture is analyzed with a flow particle image analyzer FPIA-3000 from Sysmex Corp. The number of particles to be measured is set at 18,000. From the resulting data are calculated a number average particle size and an average circularity. The term “number average particle size” as used herein denotes a number average circle equivalent diameter.

The amount of free zinc-containing particles is determined by analyzing a toner sample as described above, counting transparent amorphous particles (i.e., zinc-containing particles) out of the total projected particles, and calculating the number percentage of the transparent amorphous particles (i.e., zinc-containing particles) in the total count.

The number average particle size and average circularity of zinc-containing particles per se are determined using the zinc-containing particles as a sample in the manner described.

While any zinc-containing particles may be used as an external additive in the invention, zinc stearate particles are preferred.

As stated previously, the amount of free zinc-containing particles in a toner can be controlled by appropriately selecting the particle size or the amount of zinc-containing particles to be added. It is also controllable through appropriate selection of the method of attaching the external additive to the toner particles and the number of revolution and the blending time in mixing the external additive with the toner particles.

The external additive may be attached and held to the surface of toner mother particles by applying high speed shearing force using, for example, a high speed mixing machine. Examples of suitable mixing machines include, but are not limited to, Henschel Mixer (e.g., from Mitsui Miike Machinery Co., Ltd.), Mechanofusion System (from Hosokawa Micron Corp.), Mechanomill (from Okada Seiko Co., Ltd.), and Nobilta (from Hosokawa Micron). In the cases where toner particles are produced in a wet process, the external additive may be added in a wet system. After addition of the external additive, the toner may be subjected to sieving.

As a synthesis method for metal salts of fatty acid such as zinc stearate, there are a double decomposition process (in which a fatty acid alkali soap and a non-alkali metal salt are reacted with each other in water to precipitate metal soap) and a direct process (in which a fatty acid and a metal oxide or hydroxide are reacted directly with each other).

The double decomposition process generally proceeds through reaction formulae (1) and (2):

CₙH₂ₙ₊₁COOH+NaOH→CₙH₂ₙ₊₁COONa+H₂O (1)

2CₙH_{2N+1}COONa+ZnCl₂→(CₙH₂ₙ₊₁COO)₂Zn↓+2NaCl (2)

Because a fatty acid sodium salt is once formed as an intermediate as shown by formula (1), part of the fatty acid sodium salt remains as unreacted impurity in the fatty acid zinc salt. In the direct process, because a fatty acid (e.g., stearic acid) is directly reacted with a metal oxide (e.g., ZnO) or a metal hydroxide (e.g., Zn(OH)₂), no fatty acid sodium salt is by-produced In the exemplary embodiment of the invention, the synthesis by the direct process is preferable.

Other components constituting the toner of the invention will be described in detail.

### <Binder Resin>

The binder resin fabricating the toner particles preferably contains a crystalline resin to provide low-temperature fixability. In general, using a crystalline resin as a binder provides a low-temperature fixing toner but tends to cause the toner to vary in chargeability when the toner is left to stand under a high temperature and high humidity condition. As a result, the transfer efficiency is reduced, and a filming phenomenon is likely to occur. The toner of the invention, in contrast, allows use of a crystalline resin as a binder to achieve low temperature fixing while preventing filming.

The crystalline resin as referred to herein is defined in terms of thermal characteristics and molecular weight as follows. The crystalline resin does not exhibit a stepwise change in endothermic heat quantity but a clear endothermic peak in differential scanning calorimetry (DSC). Specifically, in DSC performed at a rate of temperature rise of 10° C./min, the endothermic peak has a half width value of 8° C. or less. Additionally, the crystalline resin has a weight average molecular weight Mw of 4,000 to 50,000 in gel permeation chromatography (GPC).

DSC is carried out using DSC-60A from Shimadzu Corp., a sample weighing 8 mg, and alumina powder as a correction standard. The rate of temperature rise is 10° C./min. As used herein, the term “half width value” means the half width value of an endothermic peak based on the high temperature side baseline.

GPC is carried out using a chromatograph HLC-8120GPC, SC-8020 (from Tosoh Corp.) equipped with two columns TSKgel, Super HM-H (from Tosoh Corp.; 6.0 mm ID×15 cm) and an RI detector (Refractive Index Detector) and tetrahydrofuran as an eluent under conditions of a sample concentration of 0.5%, a flow rate of 0.6 ml/min, an injection size of 10 μl, and a system temperature of 40° C. A calibration curve is prepared using ten polystyrene standards, TSK A-500, F-1, F-10, F-80, F-380, A-2500, F-4, F-40, F-128, and F-700, all from Tosoh Corp.

The Mw of the crystalline resin is about 4,000 to about 50,000, preferably about 6,000 to about 30,000, more preferably about 7,000 to about 15,000. When a crystalline resin with an Mw of 4,000 or more is used as a binder, non-uniform fixing caused by the toner penetrating the surface of a transfer-receiving material, such as paper, during fixing is reduced, and the fixed toner image has good resistance to flexing. In using a crystalline resin with an Mw of 50,000 or less, it is easy to control reduction of viscosity while the resin is molten, thereby eliminating the offset and other problems.

Any resin having crystallinity may serve as a crystalline resin, including crystalline polyester resins and crystalline vinyl resins. Crystalline polyester resins are preferred in terms of adhesion to paper in fixing, chargeability, and melting temperature controllability in a preferred temperature range. Crystalline aliphatic polyester resins are particularly preferred for their appropriate melting temperatures.

It may be noted that a crystalline resin alone is less strong than an amorphous resin and can be less reliable in the form of powder. When a crystalline resin is used alone, blocking in the developing machine or filming on a photoreceptor can occur particularly when the toner is stored in a high temperature environment. It is then preferred to use a crystalline resin in combination with an amorphous resin.

### [Crystalline Resin]

The crystalline resin for use in the invention preferably has a melting temperature of about 45° C. to about 110° C., more preferably about 50° C. to about 100° C., even more preferably about 55° C. to about 90° C. The crystalline resin having a melting temperature of 45° C. or higher provides a toner with improved storage stability. The crystalline resin with a melting temperature of 110° C. or lower provides a toner with improved low-temperature fixability. As used herein, the term “melting temperature” of a crystalline resin means a value determined in accordance with ASTM D3418-8.

As stated, useful crystalline resins include crystalline polyester resins and crystalline vinyl resins. Crystalline polyester resins are preferred in terms of adhesion to paper when fused, chargeability, and ease of melting temperature control within the preferred temperature range recited above. Crystalline aliphatic polyester resins are particularly preferred for ease of obtaining a desired melting temperature.

The crystalline polyester resins include those synthesized from a polycarboxylic acid (preferably dicarboxylic acid) component and a polyol (preferably diol) component. As referred to herein, the term “crystalline polyester resin” is intended to include not only homopolymers but copolymers containing not more than 50% by weight of a comonomer component in addition to the main chain of a crystalline polyester resin.

The polycarboxylic acid component is preferably an aliphatic dicarboxylic acid, more preferably a linear dicarboxylic acid. Examples thereof include, but are not limited to, oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid, and their lower alkyl esters and acid anhydrides.

The polycarboxylic acid component may contain a dicarboxylic acid component having a double bond, a dicarboxylic acid component having a sulfonic acid group, and the like in addition to the aliphatic dicarboxylic acid component. The term “dicarboxylic acid component having a double bond” embraces a component derived from a dicarboxylic acid having a double bond and a component derived from a lower alkyl ester, an acid anhydride, or a like derivative of the dicarboxylic acid having a double bond. The term “dicarboxylic acid component having a sulfonic acid group” includes a component derived from a dicarboxylic acid having a sulfonic acid group and a component derived from a lower alkyl ester, an acid anhydride, or a like derivative of the dicarboxylic acid having a sulfonic acid group.

The dicarboxylic acid component with a double bond is able to crosslink the whole resin and is therefore suitably used to prevent hot offset during fusing (fixing) of the toner image. Examples of such a dicarboxylic acid include, but are not limited to, fumaric acid, maleic acid, 3-hexenedioic acid, and 3-octenedioic acid; and their lower alkyl esters and acid anhydrides. Preferred of them are fumaric acid and maleic acid for low cost.

The dicarboxylic acid component with a sulfonic acid group is effective in facilitating dispersing a coloring agent, such as a pigment. In the case where toner particles are formed by emulsifying or suspending the whole resin in water, the presence of a sulfonic acid group makes it feasible to accomplish the emulsifying or suspending without the aid of, or with a small amount of, a surfactant as explained infra. Examples of such a dicarboxylic acid include, but are not limited to, sodium 2-sulfoterephthalate, sodium 5-sulfoisophthalate, and sodium sulfosuccinate; and their lower alkyl esters and acid anhydrides. Sodium 5-sulfoisophthalate is preferred of them for the consideration of cost.

The polycarboxylic acid components other than the aliphatic dicarboxylic acid components, i.e., the dicarboxylic acid components having a double bond and/or the dicarboxylic acid components having a sulfonic acid group are preferably used in an amount of 1 to 20 constituent mol %, more preferably 2 to 10 constituent mol %, based on the total polycarboxylic acid components.

At 1 constituent mol % or more, a coloring agent, even a pigment is well dispersible in toner mother particles. In the cases when a toner is prepared by an aggregation/coalescence process, the emulsified particles in a dispersion have a suitable size, allowing for toner particle size adjustment by aggregation. At 20 constituent mol % or less, good crystallinity of the crystalline polyester resin is maintained, the melting temperature does not fall, and the resulting image has good storage stability. In the cases when a toner is prepared by an emulsion polymerization/aggregation process, the emulsified particles in a dispersion maintain a suitable size and form a latex without dissolving in water.

The unit “constituent mol %” as used herein is a percentage taking each constituent (polycarboxylic acid or polyol component) composing a polyester resin as one unit (1 mole).

The polyol component is preferably an aliphatic diol. Examples of suitable aliphatic diols include, but are not limited to, ethylene glycol, 1,3-propanediol, 1,4-butanediol, 1,5-pentanediol, 1,6-hexanediol, 1,7-heptanediol, 1,8octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol.

The polyol component preferably contains an aliphatic diol component in a proportion of at least 80 constituent mol %, more preferably 90 constituent mol % or more, and, if desired, other diol components. At 80 constituent mol % or more, the polyester resin has good crystallinity, maintains a suitable melting temperature, and provides a toner with improved resistance to blocking and improved low temperature fixability, and the resulting fused toner image has good storage stability.

The other diol components that may be used where needed include diol components having a double bond and diol components having a sulfonic acid group.

Examples of the dial with a double bond include 2-butene-1,4-diol, 3-butene-1,6-diol, and 4-butene-1,8-diol. Examples of the diol with a sulfonic acid group include sodium 1,4dihydroxybenzene-2-sulfonate, sodium 1,3-dihydroxymethylbenzene-5-sulfonate, and sodium 2-sulfo-1,4-butanediol.

In using the polyol component other the linear aliphatic diol component (i.e., the diol component with a double bond and/or the diol component with a sulfonic acid group), it is used in a proportion of 1 to 20 constituent mol %, more preferably 2 to 10 constituent mol %, based on the total polyol components. At 1 constituent mol % or more, good dispersing properties for a pigment are obtained, and the emulsified particle size is prevented from becoming too large, allowing for toner particle size adjustment by aggregation. At 20 constituent mol % or less, the polyester resin has good crystallinity and maintains a suitable melting temperature, and the resulting fused image has good storage stability. Formation of too small emulsified particles is also avoided. Too small emulsified particles can dissolve in water, resulting in a failure to form a latex.

The crystalline polyester resin may be prepared by any process. For example, commonly used polyester polymerization processes in which a polycarboxylic acid component and a polyol component are allowed to react with each other, such as a direct polycondensation process or an ester interchange process, can be used. The process to be employed is chosen as appropriate to the monomers. The molar ratio of the polycarboxylic acid component to the polyol component shall not be indiscriminately discussed, as varying depending on the reaction condition and so on. In general, however, it is usually about 1/1.

The polymerization reaction is preferably carried out at 10° C. to 230° C. while, if necessary, removing water or alcohol resulting from the condensation reaction under reduced pressure. When monomers do no dissolve in one another at the reaction temperature, a high boiling solvent may be added as a dissolving assistant. The polycondensation reaction is preferably performed while removing the high boiling solvent by evaporation. When a poorly compatible monomer is present in a copolymerization system, it is advisable that the poorly compatible monomer is previously condensed with the polycarboxylic acid component or the polyol compound (to be polycondensed) and the resulting condensation product is subjected to polycondensation together with the main component.

Examples of catalysts that can be used in the preparation of the crystalline polyester resins include compounds of an alkali metal (e.g., sodium or lithium), compounds of an alkaline earth metal (e.g., magnesium or calcium), compounds of other metals (e.g., zinc, manganese, antimony, titanium, tin, zirconium, and germanium), phosphorous acid compounds, phosphoric acid compounds, and amine compounds.

Specific examples of useful catalysts are sodium acetate, sodium carbonate, lithium acetate, calcium acetate, zinc stearate, zinc naphthenate, zinc chloride, zinc acetate, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin acetate, tin oxalate, tetraphenyltin, dibutyltin dichloride, dibutyltin oxide, diphenyltin oxide, tin disulfide, zirconium tetrabutoxide, zirconium naphthenate, zirconyl carbonate, zirconyl acetate, zirconyl stearate, zirconyl octylate, germanium oxide (germanium dioxide), triphenyl phosphite, tris(2,4-di-t-butylphenyl)phosphite, ethyltriphenylphosphonium bromide, triethylamine, and triphenylamine.

Preferred among them is dibutyltin oxide in terms of ease of obtaining low temperature fixability while minimizing objectionable gloss non-uniformity.

Examples of the crystalline vinyl resins are those prepared from (meth)acrylic acid esters with long-chain alkyl or alkenyl, such as amyl(meth)acrylate, hexyl(meth)acrylate, heptyl(meth)acrylate, octyl(meth)acrylate, nonyl(meth)acrylate, decyl(meth)acrylate, undecyl(meth)acrylate, tridecyl(meth)acrylate, myristyl(meth)acrylate, cetyl(meth)acrylate, stearyl(meth)acrylate, oleyl(meth)acrylate, and behenyl(meth)acrylate. As used herein, the term “(meth)acryl” and its cognate terms are intended to include both acryl and methacryl.

For the purpose of adjusting the melting temperature, molecular weight, and the like of a crystalline resin, a compound having a shorter-chain alkyl or alkenyl group or an aromatic ring may be used in combination with the above described polymerizable monomers. For instance, examples of other dicarboxylic acid components include alkyldicarboxylic acids, such as succinic acid, malonic acid, and oxalic acid; aromatic dicarboxylic acids, such as phthalic acid, isophthalic acid, terephthalic acid, homophthalic acid, 4,4′-bibenzoic acid, 2,6-naphthalenedicarboxylic acid, and 1,4-naphthalenedicarboxylic acid; and nitrogen-containing aromatic dicarboxylic acids, such as dipicolinic acid, dinicotinic acid, quinolinic acid, and 2,3-pyrazinedicarboxylic acid. Examples of other diol components include short-chain alkyl diols, such as ethanediol, propylene glycol, and butanediol. Examples of useful vinyl polymerizable monomers containing a short-chain alkyl group include (meth)acrylic acid short-chain alkyl or alkenyl esters, such as methyl(meth)acrylate, ethyl(meth)acrylate, propyl(meth)acrylate, and butyl(meth)acrylate; vinyl nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, butadiene, and isoprene. These polymerizable monomers may be used either individually or as mixed.

### [Amorphous Resin]

As previously stated, the toner particles may contain an amorphous resin in combination with the crystalline resin.

The weight average molecular weight Mw of usable amorphous resins is preferably, but not limited to, 8,000 to 100,000, more preferably 12,000 to 50,000. By using an amorphous resin having an Mw falling within that range, an image with excellent flexibility/strength balance is obtained.

The amorphous resin preferably contains a monomer unit derived from an alkenylsuccinic acid or its anhydride or trimellitic acid or its anhydride. An alkenylsuccinic acid or its anhydride provides a resin mutually easily soluble with the crystalline polyester resin owing to the highly hydrophobic alkenyl group.

Examples of the alkenylsuccinic acid component include n-dodecenylsuccinic acid, isododecenylsuccinic acid, and n-octenylsuccinic acid; and acid anhydrides, acid chlorides, and C1-C3 lower alkyl esters thereof.

Incorporating a tri- or more functional polycarboxylic acid provides a polymer capable of crosslinking. The crystalline polyester resin having once dissolved can be immobilized by the crosslinked structure. Examples of the tri- or more functional polycarboxylic acid include hemimellitic acid, trimellitic acid, trimesic acid, mellophanic acid, prehnitic acid, pyromellitic acid, mellitic acid, and 1,2,3,4-butanetetracarboxylic acid; and acid anhydrides, acid chlorides, and C1-C3 lower alkyl esters thereof.

The amorphous polyester resin may be prepared by any of the above described common processes for synthesizing polyesters. Carboxylic acid components used to prepare the amorphous polyester resin can be selected from those mentioned above with respect to the crystalline polyester resin. Likewise, diol components to be used may be chosen from those recited above. In addition to the aliphatic diols described with respect to the synthesis of the crystalline polyester resin, other diol compounds may be used, such as bisphenol A, a bisphenol A ethylene oxide adduct, a bisphenol A propylene oxide adduct, hydrogenated bisphenol A, bisphenol S, a bisphenol S ethylene oxide adduct, and a bisphenol S propylene oxide adduct. It is particularly preferred to use bisphenol A or its derivative, such as a bisphenol A ethylene oxide adduct or a bisphenol A propylene oxide adduct, in terms of ease of toner preparation, heat resistance, and transparency. Each of the carboxylic acid component and the alcohol component may be composed of a plurality of compounds in particular, bisphenol A is effective in improving heat resistance.

### [Crosslinking of Binder Resin]

If desired, a crosslinking agent may be added to the crystalline resin binder and the amorphous resin binder, which is used where necessary, to prevent gloss non-uniformity, color development non-uniformity, hot offset, and the like during fixing in a high temperature range.

Examples of suitable crosslinking agents include aromatic polyfunctional vinyl compounds, such as divinylbenzene and divinylnaphthalene; polyfunctional vinyl esters of aromatic polycarboxylic acids, such as divinyl phthalate, divinyl isophthalate, divinyl terephthalate, divinyl homophthalate, di/trivinyl trimesate, divinyl napthalenedicarboxylate, and divinyl biphenylcarboxylate; divinyl esters of nitrogen-containing aromatic compounds, such as divinyl pyridinedicarboxylate; unsaturated heterocyclic compounds, such as pyrrole and thiophene; vinyl esters of unsaturated heterocyclic carboxylic acids, such as vinyl pyromucate, vinyl furancarboxylate, vinyl pyrrole-2-carboxylate, and vinyl thiophenecarboxylate; (meth)acrylic acid esters of straight-chain polyhydric alcohols, such as butanediol methacrylate, hexanediol acrylate, octanediol methacrylate, decanediol methacrylate, and dodecanediol methacrylate; (meth)acrylic acid esters of branched or substituted polyhydric alcohols; such as neopentyl glycol dimethacrylate and 2-hydroxy-1,3-diacryloxypropane; polyethylene glycol di(meth)acrylates, polypropylene polyethylene glycol di(meth)acrylates; and polyfunctional vinyl esters of polycarboxylic acids, such as divinyl succinate, divinyl fumarate, vinyl/divinyl maleate, divinyl diglycolate, vinyl/divinyl itaconate, divinyl acetonedicarboxylate, divinyl glutarate, divinyl 3,3′-thiodipropiodate, divinyl/trivinyl trans-aconitate, divinyl adipate, divinyl pimelate, divinyl suberate, divinyl azelate, divinyl sebacate, divinyl dodecanedicarboxylate, and divinyl brassylate.

In preparing the crystalline polyester resin, an unsaturated polycarboxylic acid, such as fumaric acid, maleic acid, itaconic acid, or trans-aconitic acid, may be copolymerized, and the resulting resin may be crosslinked at its multiple bonds or by using another vinyl compound. The crosslinking agents may be used either individually or in combination of two or more thereof.

Crosslinking using a crosslinking agent may be effected by a method in which the crosslinking agent is copolymerized with the polymerizable monomer to accomplish crosslinking or a method in which the unsaturated moiety is left in the binder resin and, after polymerization of the binder resin or after toner preparation, subjected to crosslinking.

In the case of a polyester resin binder, the polymerizable monomer can be polymerized by polycondensation. The catalyst for polycondensation is selected appropriately from the above described examples of polycondensation catalysts. In the case of a vinyl resin binder, the polymerizable monomer can be polymerized by radical polymerization.

While any radical polymerization initiator may be used, initiators capable of initiating emulsion polymerization are preferred. Examples include peroxides, such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenyl acetate tert-butyl hydroperoxide, tert-butyl performate, tert-butyl peracetate, tert-butyl perbenzoate, tert-butyl perphenylacetate, tertbutyl permethoxyacetate, and tert-butyl per-N-(3-toluyl)carbamate; azo compounds, such as 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-amidinopropane)nitrate, 2,2′-azobisisobutane, 2,2′-azobisisobutylamide, 2,2′-azobisisobutyronitrile, methyl 2,2′-azobis-2-methylpropionate, 2,2′-dichloro-2,2′-azobisbutane, 2,2′-azobis-2-methylbutyronitrile, dimethyl 2,2′-azobisisobutyrate, 1,1′-azobis(sodium 1-methylbutyronitrile-3-sulfonate), 2-(4-methylphenylazo)-2-methylmalonodinitrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methylvaleronitrile, dimethyl 4,4′-azobis-4-cyanovalerate, 2,2′-azobis-2,4-dimethylvaleronitrile, 1,1′-azobiscyclohexanenitrile, 2,2′-azobis-2-propylbutyronitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′azobiscumene, ethyl 4-nitrophenylazobenzylcyanoacetate, phenylazodiphenylmethane, phenylazotriphenylmethane, 4-nitrophenylazotriphenylmethane, 1,1′-azobis-1,2-diphenylethane, poly(bisphenol A-4,4′-azobis-4-cyanopentanoate), and poly(tetraethylene glycol-2,2′-azobisisobutyrate); 1,4-bis(pentaethylene)-2-tetrazene, and 1,4-dimethoxycarbonyl-1,4-diphenyl-2-tetrazene. These polymerization initiators may also usable as a crosslinking reaction initiator.

While the binder resin for use in the invention has been described predominantly with reference to crystalline polyester resins and amorphous polyester resins, other binder resins may be used according to necessity. Useful other binder resins include homo- and copolymers obtained from one or more than one monomers selected from, for example, styrenes, such as styrene, p-chlorostyrene, and α-methylstyrene; (meth)acrylates, such as methyl(meth)acrylate, ethyl(meth)acrylate, n-propyl(meth)acrylate, butyl(meth)acrylate, lauryl(meth)acrylate, and 2-ethylhexyl(meth)acrylate; ethylenically unsaturated compounds, such as (meth)acrylic acid and sodium styrenesulfonate; vinylnitriles, such as (meth)acrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene; mixtures of the homo- and copolymers; non-vinyl condensation resins, such as epoxy resins, polyester resins, polyurethane resins, polyamide resins, cellulose resins, and polyether resins; mixtures of the above described vinyl resins and the non-vinyl condensation resins; and graft polymers obtained by polymerizing a vinyl monomer in the presence of these resins.

### <External Additive>

The toner of the invention may contain a known external additive in addition to the zinc-containing particles. Useful external additives include particulate inorganic compounds, such as silica, alumina, titania, calcium carbonate, magnesium carbonate, and tricalcium phosphate. The external additive may be attached and held to the surface of toner particles by, though not exclusively, applying shearing force in a dry state.

The inorganic particles used as an external additive preferably have a primary particle size of about 5 nm to about 2 μm, more preferably about 5 nm to about 500 nm. In a preferred mode, two or more kinds of the inorganic particles are used in combination according to necessity In particular, an external additive with a median size of 100 nm or greater has weak adhesive force to toner particles' surface and therefore undergoes little structural change in long-term use, which is effective in retaining the structure of small-diameter products.

The inorganic particles preferably have a BET specific surface area of 20 m²/g to 500 m²/g. The inorganic particles are preferably mixed into a toner in an amount of 0.01% by weight to 5% by weight, more preferably 0.01% by weight to 2.0% by weight.

Examples of useful inorganic particles include silica powder, alumina, titanium oxide, barium oxide, magnesium titanate, calcium titanate, strontium titanate, zinc oxide, siliceous sand, clay, mica, wollastonite, diatomaceous earth, chromium oxide, cerium oxide, rouge, antimony trioxide, magnesium oxide, zirconium oxide, barium sulfate, barium carbonate, calcium carbonate, silicon carbide, and silicon nitride, with silica powder being preferred.

The silica powder for use in the invention is a powder having an Si—O—Si bond prepared by either a dry or wet process. It may be anhydrous silicon dioxide or otherwise may be aluminum silicate, sodium silicate, potassium silicate, magnesium silicate, zinc silicate or the like. Powder having an SiO₂ content of at least about 85% by weight is preferred.

Various commercially available silica products may be used, of which those having a hydrophobic group on the surface are preferred. Examples of such silica products are AEROSIL R-972, R-974, R-805, and R-812 (all from Aerosil), and Talanox 500 (from Talco). Also useful is silica powder treated with a silane coupling agent, a titanium coupling agent, silicone oil, or silicone oil having amine on its side chain.

### <Coloring Agent>

The coloring agent that can be used in the toner of the invention may be any of known coloring materials, including carbon black species, such as furnace black, channel black, acetylene black, and thermal black; inorganic pigments, such as rouge, iron blue, and titanium oxide; azo pigments, such as Fast Yellow, Disazo Yellow, Pyrazolone Red, Chelate Red, Brilliant Carmine, and Para Brown; phthalocyanine pigments, such as copper phthalocyanine and metal-free phthalocyanine; and condensed polycyclic pigments, such as Flavanthrone Yellow, Dibromoanthrone Orange, Perylene Red, Quinacridone Red, and Dioxane Violet.

Other examples of useful coloring agents include Chromium Yellow, Halnza Yellow, Benzidine Yellow, Threne Yellow, Quinoline Yellow, Permanent Orange GTR, Pyrazolone Orange, Vulcan Orange, Watching Red, Permanent Red, DuPont Oil Red, Lithol Red, Rhodamine B Lake, Lake Red C, Rose Bengal, Aniline Blue, Ultramarine Blue, Calco Oil Blue, Methylene Blue chloride, Phthalocyanine Blue, Phthalocyanine Green, Malachite Green oxalate, C.I. Pigment Red 48:1, C.I. Pigment Red 122, C.I. Pigment 57:1, C.I. Pigment Yellow 12, C.I. Pigment Yellow 97, C.I. Pigment Yellow 17, C.I. Pigment Blue 15:1, and C.I. Pigment Blue 15:3. These coloring agents may be used either individually or as a combination of two or more thereof.

The coloring agent content in the toner is preferably 1 to 30 parts by weight per 100 parts by weight of the binder resin. If desired, a surface-treated coloring agent may be used, and a dispersant for pigment may be used. The toner of the invention may be formulated to be a yellow toner, a magenta toner, a cyan toner, a black toner, etc, by appropriate selection of the coloring agents.

### <Release Agent>

The toner of the invention contains a release agent. Any known release agent may be used in the invention. Examples of useful release agents include, but are not limited to, naturally occurring waxes, such as carnauba wax, rice wax, and candelilla wax; synthetic or mineral/petroleum waxes, such as low molecular polypropylene, low molecular polyethylene, sasol wax, microcrystalline wax, Fischer-Tropsch wax, paraffin wax, and montan wax; and ester waxes, such as fatty acid esters and montanic acid esters. The release agents may be used either individually or in combination of two or more thereof.

The melting temperature of the release agent is preferably about 50° C. or higher, more preferably about 60° C. or higher, in terms of storage stability and preferably about 110° C. or lower, more preferably about 100° C. or lower, in view of offset prevention.

The content of the release agent in the toner is preferably about 1 part by weight to about 30 parts by weight, more preferably about 2 parts by weight to about 20 parts by weight per 100 parts by weight of the binder resin. When the release agent content is less than 1 part, the effect of adding the release agent is insubstantial, allowing hot offset to occur in high temperature. Addition of more than 30 parts of a release agent adversely affects the chargeability of the toner. Furthermore, excessive addition of a release agent reduces the mechanical strength of the toner particles, allowing the toner particles to be destroyed due to the stress inside the developing machine, which can invite carrier contamination. In the cases where the toner is a color toner, domains of the release agent are liable to remain in the fused image, which can deteriorate transparency for OHP use.

### <Other Components>

If desired, the toner of the invention may contain other components, such as an internal additive, a charge controlling agent, inorganic particles, and organic particles.

The internal additives are exemplified by magnetic substances, such as metals, metal alloys, and metal compounds, e.g., ferrite, magnetite, reduced iron, cobalt, nickel, and manganese.

Examples of useful charge controlling agents include quaternary ammonium salts, nigrosin compounds; aluminum, iron or chromium complex dyes; and triphenylmethane pigments.

The inorganic particles are added chiefly for toner viscoelasticity adjustment. Any type of inorganic particles that are commonly used as a toner external additive, such as silica, alumina, titania, calcium carbonate, magnesium carbonate, calcium phosphate, and cerium oxide, may be used.

### <D50v, GSDv, GSDp>

The toner particles of the invention preferably have a volume average particle diameter D50v of 3 to 10 μm, more preferably 3.8 to 6.0 μm, as measured in accordance with the method below. With a D50v of at least 3 μm, the toner exhibits good chargeability so that toner flying or scattering is reduced and image fog is prevented. With a D50v of not more than 10 μm, the toner achieves a satisfactory image resolution in favor of high image qualities.

The toner particles of the invention preferably have a volume average particle size distribution index (also referred to as a geometric standard deviation by volume, hereinafter abbreviated as GSDv) of about 1.28 or less. The GSDv will be defined later. With a GSDv of 1.28 or less, the toner forms an image having good clarity and resolution. The toner particles preferably have a number average particle size distribution index (also referred to as a geometric standard deviation by number, hereinafter abbreviated as GSDp) of 1.30 or less. The GSDp will be defined later. A GSDp of 1.30 or less means that the proportion of small-diameter toner particles is so small as to secure initial toner performance and reliability for the following reason. As is well known in the art, small diameter toner particles tend to be difficult to control electrostatically because of their large adhesive force and, particularly in a two-component developer system, tend to remain on the carrier. In such cases, the small diameter toner particles can cause carrier contamination, resulting in accelerated deterioration of the carrier.

Particularly in the transfer step, small diameter toner particles developed on an image holding member are difficult to transfer, resulting in poor transfer efficiency. This can result in such problems as an increase of a waste toner and poor image qualities. When the problem arises, electrostatically uncontrolled toner particles or oppositely charged toner particles will increase and can contaminate the surroundings. These uncontrolled toner particles readily deposit particularly on a charging roller via an image holding member and the like, which can result in poor charging.

Moreover, small diameter toner particles tend to have insufficient capability of holding a crystalline resin therein. This can lead to a filming phenomenon on an image holding member On the other band, large-diameter toner particles tend to fracture in a developing machine, be blown out from a developing machine, and cause image quality reduction due to insufficient charging.

The fact that the GSDv and GSDp fall within the respective ranges recited above indicates that the proportion of small diameter toner particles is low so that the aforementioned problems are less likely to arise.

The GSDv is more preferably about 1.25 or less, and the GSDp is preferably 1.25 or less.

The D50v, GSDv, and GSDp are determined using Multisizer II from Beckman Coulter, Inc. as a measuring instrument and ISOTON-II from Beckman Coulter as an electrolyte solution. A sample dispersion to be analyzed is prepared by putting a toner weighing between 0.5 mg and 50 mg in 2 ml of a 5 wt % aqueous solution of a surfactant as a dispersant (e.g., a sodium alkylbenzenesulfonate), adding the mixture to 100 to 150 ml of the electrolyte solution, and dispersing the electrolyte solution having the toner suspended in an ultrasonic disperser for 1 minute. An aperture diameter of 100 μm is chosen to determine the particle size distribution between 1.587 μm and 64.0 μm. The number of particles to be analyzed is 50,000.

Based on the thus determined particle size distribution, the volume average and the number average distributions, respectively, are plotted as a function of the divided regions (channels) from the side of the small particle size to draw cumulative particle size distribution curves. The particle diameters at which a cumulative percentage of 16% is attained are referred to as a cumulative volume average particle size D16v and a cumulative number average particle size D16p, respectively. The particle diameters at which a cumulative percentage of 50% are attained are referred to as a cumulative volume average particle size D50v and a cumulative number average particle size D50p, respectively. The particle diameters at which a cumulative percentage of 84% are attained are referred to as a cumulative volume average particle size D84v and a cumulative number average particle size D84p, respectively. The volume average particle size distribution index GSDv is defined to be D84v/D16v, and the number average particle size distribution index GSDp is defined to be D84p/D16p.

The toner particles preferably have an average circularity of from about 0.940 to about 0.985. Toner particles with an average circularity of 0.940 or greater have shape stability and exhibit good transfer, durability, and flowability. With an average circularity of 0.985 or less, the proportion of spherical particles is in a suitable ranger providing good toner cleanability. The average circularity of the toner particles is more preferably from about 0.950 to about 0.975.

In the case of a toner containing a crystalline resin, as the average circularity approaches 1 (as the particles become more spherical), spherical toner particles with an increased crystalline resin component tend to increase in number. This can lead to filming due to deposition on a portion of an image holding member in contact with a cleaning member, deterioration of the cleaning member due to increase in torque, and filming on an image holding member. As the average circularity approaches 0 (as the particles become more amorphous), the toner particles can fracture in the developing machine to have the crystalline resin component exposed on the fracture surface. This can result in poor chargeability.

The average circularity of toner particles is determined by the aforementioned method using a flow particle image analyzer FPIA-3000 from Sysmex Corp.

### (Toner Production Method)

While the toner of the invention may be prepared by any known processes for the preparation of a toner, it is preferably prepared by a wet process, which includes the steps of forming toner mother particles containing at least a crystalline resin and a release agent in water, an organic solvent, or a mixture thereof and washing and drying the toner mother particles.

Taking, for instance, toner preparation called a dissolution/suspension process in which toner mother particles are obtained from an aqueous/oily phase mixed suspension will be described. The dissolution/suspension process includes a liquid preparation step, a suspending step, a solidifying step, a cleaning step, and a drying step.

### <Liquid Preparation Step>

In the liquid preparation step, an oily phase is prepared by dispersing toner components, such as a binder resins, a coloring agent, a release agent, and a viscosity modifier, in an organic solvent. An aqueous phase, which is used to emulsify the oily phase, is prepared by dispersing a surfactant, a thickener, an interface-forming material, etc. in water.

### <Suspending Step>

In the suspending step, the oily phase and the aqueous phase are mixed, and an external shearing force, such as a mechanical shearing force or ultrasonication, is applied to emulsify the oily phase in the aqueous phase to a desired droplet size.

### <Solidifying Step>

In the solidifying step, the emulsified oil droplets of the emulsion are solidified into particles, from which toner mother particles originate, by removing the solvent. Solvent removal may he effected by reducing pressure, overheating, contact with a gas phase, or a like means.

### <Cleaning Step>

In the cleaning step, the slurry from the solidifying step is freed of the secondary materials used for preparing the suspension by using a surfactant, an acid, or a base. The conditions of the cleaning step should be decided so as to provide chargeability demanded in an image forming apparatus where the toner is to be used.

### <Drying Step>

The drying step is preferably carried out by, though not exclusively, freeze-drying, air flow drying (using, e.g., Flash Jet Drier), fluidized bed drying, or vibrating fluidized bed drying. The external additive of the invention and, where necessary, other various external additives described above are added to the dried toner particles (toner mother particles).

### (Electrostatic Image Developer)

The electrostatic image developer (simply “developer”) of the second aspect of the invention essentially contains the toner of the first aspect of the invention and optionally contains other components according to the purpose.

More specifically, when used alone, the toner of the invention provides a one-component developer. When combined with a carrier, the toner of the invention provides a two-component developer. In a two-component developer the toner is preferably used in a concentration of 1% to 10% by weight.

The carrier is not particularly limited, and known carriers may be used.

The core material of the resin-coated carrier is of, e.g., iron, ferrite, or magnetite and usually has an average particle size of about 30 to 200 μm.

Examples of the coating resin include homo- and copolymers of styrene, such as styrene, p-chlorostyrene, and α-methylstyrene, α-methylene aliphatic monocarboxylic acid esters, such as methyl(meth)acrylate, ethyl acrylate, n-propyl(meth)acrylate, lauryl(meth)acrylate, and 2-ethylhexyl(meth)acrylate, nitrogen-containing acrylates, such as dimethylaminoethyl methacrylate, vinylnitriles, such as (meth)acrylonitrile, vinylpyridines, such as 2-vinylpyridine and 4-vinylpyridine, vinyl ethers, such as vinyl methyl ether and vinyl isobutyl ether, vinyl ketones, such as vinyl methyl ketone, vinyl ethyl ketone, and vinyl isopropenyl ketone, olefins, such as ethylene and propylene, and fluorine-containing vinyl monomers, such as vinylidene fluoride, tetrafluoroethylene, and hexafluoroethylene; silicones, such as methyl silicone and methylphenyl silicone; polyesters having bisphenol, glycol, etc.; epoxy resins, polyurethane resins, polyamide resins, cellulose resins, polyether resins, and polycarbonate resins. These resins may be used either individually or as a mixture of two or more thereof.

The amount of the coating resin is preferably 0.1 to 10 parts, more preferably 0.5 to 3.0 parts, by weight per 100 parts by weight of the core material. The preparation of resin-coated carrier is carried out using, for example, a heat kneader, a heat Henschel mixer, or UM Mixer. A heated fluidized rolling bed or a heating kiln may be useful, depending on the amount of the coating resin. The toner and the carrier may be mixed in any ratio decided as appropriate to the intended use.

### (Image Forming Method and Apparatus)

Image formation using the toner of the invention is carried out by known electrophotographic techniques. Specifically, the image forming method according to the third aspect of the invention includes the steps of (a) forming an electrostatic latent image on the surface of an image holding member (latent image formation step), (b) developing the latent image on the image holding member with a developer containing a toner to form a toner image (development step), (c) transferring the toner image on the image holding member to a transfer-receiving material (transfer step), and (d) fixing the toner image on the transfer-receiving material. The image forming method of the invention is characterized in that the developer is the toner of the invention or the developer of the invention.

The image forming method may further include an additional step known in the art of electrophotography. For example, the method may include a cleaning step in which the image holding member is cleaned after the transfer step while collecting the toner remaining on the image holding member or a toner recycling step in which the collected toner is recycled as a toner for development.

The image forming apparatus according to the fourth aspect of the invention may be conventional, except for using the toner of the first aspect of the invention. Specifically, the apparatus includes an image holding member adapted to form an electrostatic latent image thereon, a developing unit for developing the electrostatic latent image on the image holding member with a developer containing a toner to form a toner image on the image holding member, a transfer unit for transferring the toner image to a transfer-receiving material, a fixing unit for fixing the transferred toner image on the transfer-receiving material, and a cleaning unit for removing residual toner and debris from the image holding member. The apparatus of the invention is characterized by using the toner according to the invention or the developer according to the invention.

### <Latent Image Formation Step>

In the latent image formation step, the surface of an image holding member is evenly charged with a charger and then imagewise exposed using a laser optical system or an LED array to form an electrostatic latent image. Chargers include non-contact type chargers, such as a corotron and a scorotron, and contact type chargers that apply voltage to a conductive member in contact with the surface of an image holding member thereby to charge the surface of the image holding member. Either of these types of chargers may be used. In view of controlled ozone generation, environmental friendliness, and printing life, a contact type charger is preferred. The conductive member of the contact type charger may have any form, such as a brush, a blade, a pin electrode, or a roller. The latent image formation step is not limited to the embodiment described above.

### <Development Step>

In the development step, a developer holding member having a developer layer containing the toner formed on its surface is brought into contact with or close to the image holding member thereby to attract toner particles onto the latent image on the image holding member. A toner image is thus formed on the surface of the image holding member. A known development system is used. For example, development with a two-component developer is performed by, though not exclusively, cascade development or magnetic brush development.

### <Transfer Step>

In the transfer step, the toner image on the image holding member is transferred either directly or indirectly to a transfer-receiving material (or a recording medium), such as paper. In the latter case, the toner image on the image holding member is once transferred to an intermediate transfer member and then to a transfer-receiving material, such as paper.

The transfer unit that can be used to perform the transfer step is exemplified by a corotron. However, a corotron, though effective as a means for charging paper, needs high voltage as high as several kilovolts to give paper a prescribed charge quantity and therefore requires a high voltage power source. In addition to this, a corona discharge is accompanied by ozone generation, which induces deterioration of rubber parts and the image holding member. Therefore, a contact transfer system is preferred, in which an electrically conductive transfer roller having an elastic material is pressed toward the image holding member thereby to transfer the toner image to paper. The transfer unit for use in the invention is not limited to the examples described.

### <Cleaning Step>

In the cleaning step, the toner, paper dust, or any other debris remaining on the surface of the image holding member are removed by bringing a cleaning member, such as a blade, a brush, or a roller, into direct contact with the image holding member.

The most commonly used cleaning system is a blade cleaning system using a blade made of rubber, e.g., polyurethane, pressed onto the image holding member. The cleaning may also be carried out by a magnetic brush cleaning system using a magnetic brush having a rotating nonmagnetic cylindrical sleeve and magnets stationary arranged inside the sleeve and having a magnetic carrier held on the peripheral surface of the sleeve to collect the residual toner or a cleaning system in which a roller having semi-conductive resin fiber or animal hair on its surface is used, to which a bias of opposite polarity opposite to the toner is applied to remove the residual toner. In the magnetic brush cleaning system, a corotron may be used to give a pretreatment before cleaning. The cleaning system is not limited to the examples described.

### <Fixing Step>

In the fixing step, the toner image transferred to the transfer-receiving material is fixed by a fixing unit. The fixing step is preferably carried out using, though not exclusively, a heat fixing unit having a heat roller. The heat fixing unit is composed of a fixing roller and a pressure roller or belt. The fixing roller has a metal cylinder, a heater lamp inside the cylinder, and a release layer of a heat resistant resin or rubber around the cylinder. The pressure roller or belt is a metal cylinder or belt having a heat resistant elastic material layer therearound or thereon and is pressed to the fixing roller. The transfer-receiving material (recording medium) having a toner image is passed between the fixing roller and the pressure roller or belt, whereby the binder resin, the additive, and the like in the toner are fused to fix the toner image. The fixing system is not limited to the above embodiments.

A full color image is preferably formed as follows. A plurality of latent images of different colors are formed on the respective image holding members, developed by the respective developer holding members, successively transferred to the same transfer-receiving material to make a full color toner image, which is then thermally fixed in the fixing step.

Use of the toner or developer of the invention in the above described image forming method provides stability of development, transfer, and fixing performance even in, for example, a tandem electrophotographic system suited to achieve printer size reduction and high speed color printing.

The system for recycling toner is not particularly limited. For example, a toner collected in a cleaning part is sent on a conveyer belt or by a conveyor screw to a replenishing toner hopper or a developing machine, or after being mixed with a replenishing toner in an intermediate chamber, is fed to a developing machine. Preferably, the collected toner is returned directly to a developing machine, or the collected toner is mixed with a replenishing toner in an intermediate chamber and then fed to a developing machine.

When the toner is recycled, it is necessary that the strength of the toner particles be high and that the release agent be well dispersed in the toner particles and not be so much exposed on the toner surface. In this regard, since conventional toner particles containing a crystalline resin as a main binder resin and a release agent have low strength due to the large content of the crystalline resin, the particles undergo deformation or fracture when subjected to mechanical stress of recycling many times, which can cause filming. When such a toner designed for oilless fixing or low-temperature fixing is used to form images for a long period of time in an image forming apparatus equipped with a toner recycling system, there arises the problem of image quality deterioration due to the filming.

Having a wax and a crystalline resin mutually dissolving in each other and uniformly dispersed therein, in contrast, the toner particles of the invention exhibit high elasticity compared with the conventional toner. They are hardly deformed or fractured even when subjected to mechanical stress repeatedly. With the toner of the invention, therefore, filming is prevented to minimize image quality deterioration with time even when image formation is continued for a long period of time while recycling the toner on an image forming apparatus equipped with a toner recycling system.

The configuration of the image forming apparatus to carry out the image forming method described is not particularly limited. It preferably includes an image holding member that forms an electrostatic latent image thereon, a developing unit for developing the electrostatic latent image on the image holding member with a developer containing a toner to form a toner image on the image holding member, a transfer unit for transferring the toner image to a transfer-receiving material, and a fixing unit for fixing the transferred toner image on the transfer-receiving material, wherein the toner is the electrostatic image developing toner according to the invention or the developer is the electrostatic image developer according to the invention.

More preferably, the apparatus further includes a cleaning unit that collects the toner remaining on the image holding member after the toner image transfer and a toner recycling unit for reusing the toner collected by the cleaning unit as a developing toner.

The image forming apparatus having the configuration described may have a removable toner cartridge that contains a developer to be fed to a toner image forming part. The image forming apparatus may have a removable process cartridge having at least an image holding member and a toner image forming part containing a developer and adapted to supply the developer to an electrostatic latent image formed on the image holding member to form a toner image. The term “process cartridge” refers to an integral unit detachably mountable to a main assembly of the image forming apparatus and having at least an image holding member and a toner image forming part. The process cartridge may further have a charging part, an exposing part, a cleaning part, and the like.

Examples of the recording medium (transfer-receiving material) onto which a toner image is transferred include plain paper and OHP transparencies that are used in electrophotographic copiers or printers, coated paper (plain paper coated with a resin, etc.), and art paper for printing.

### EXAMPLES

The present invention will now be illustrated in greater detail by way of Examples, but it should be understood that the invention is not deemed to be limited thereto. Unless otherwise noted, all the parts are by weight.

### Examples 1 to 4 and Comparative Examples 1 to 3

### 1. Preparation of Toner Mother Particles 1

### 1-1. Preparation of Pigment Dispersion

The following components are dissolved and dispersed in a sand mill to prepare a pigment dispersion.

| | |
|---|---|
| C.I. Pigment Blue B 15:3 | 20 parts |
| Ethyl acetate | 75 parts |
| Disparlon DA-703-50 (polyester acid amide amine salt, from | 4 parts |
| Kusumoto Chemicals, Ltd.) from which the solvent had been | |
| removed | |
| Solsperse 5000 (pigment derivative, from Zeneca) | 1 part |

### 1-2. Preparation of Release Agent Dispersion

Thirty parts of paraffin wax (melting temperature: 89° C.) as a release agent and 270 parts of ethyl acetate are wet ground as cooled to 10° C. in a DCP mill SF-12 from Nippon Eirich Co., Ltd. to prepare a release agent dispersion.

### 1-3 Synthesis of Crystalline Resin (1)

In a nitrogen-purged flask are put 153 parts of adipic acid, 118 parts of 1,6-hexanediol, and 0.08 parts of dibutyltin oxide and allowed to react at 170° C. for 4 hours and then under reduced pressure at 210° C. for 4 hours to obtain crystalline resin (1) having a weight average molecular weight (Mw) of 12,000 and a melting temperature of 68° C.

### 1-4 Synthesis of Amorphous Resin (1)

In a nitrogen-purged flask are put 97 parts of dimethyl terephthalate, 78 parts of dimethyl isophthalate, 27 parts of dodecenylsuccinic anhydride, 174 parts of a bisphenol A ethylene oxide adduct, 189 parts of a bisphenol A propylene oxide adduct, and 0.08 parts of dibutyltin oxide and allowed to react at 150° C. for 4 hours and then under reduced pressure at 200° C. for 6 hours. Eight parts of trimellitic anhydride is added thereto, followed by continuing the reaction under reduced pressure for 30 minutes to obtain amorphous resin (1) having an Mw of 55,000, a glass transition temperature (Tg) of 56° C.

### 1-5. Synthesis of Amorphous Resin (2)

In a nitrogen-purged flask are put 97 parts of dimethyl terephthalate, 78 parts of dimethyl isophthalate, 27 parts of dodecenylsuccinic anhydride, 164 parts of a bisphenol A ethylene oxide adduct, 179 parts of a bisphenol A propylene oxide adduct, and 0.08 parts of dibutyltin oxide and allowed to react at 150° C. for 4 hours and then under reduced pressure at 200° C. for 6 hours to give amorphous resin (2) having an Mw of 13,000 and a Tg of 60° C.

### 1-6 Preparation of Toner Particles 1

Ten parts of crystalline resin (1), 66 parts of amorphous resin (1), 60 parts of amorphous resin (2), 34 parts of the pigment dispersion, 75 parts of the release agent dispersion, and 56 parts of ethyl acetate are mixed by thoroughly stirring until a uniform dispersion (designated dispersion A) is obtained.

Forty-five parts of calcium carbonate is dispersed in 55 parts of water. In a homogenizer (Ultra Turrax, from IKA GmBH) are put 124 parts of the resulting calcium carbonate dispersion, 99 parts of a 2% aqueous solution of carboxymethyl cellulose (Cellogen BS-H, from Daiichi Seiyaku Co., Ltd.), and 160 parts of water and stirred for 5 minutes to prepare dispersion B.

Two hundred fifty parts of dispersion A is added to 345 parts of dispersion B while stirring on Ultra Turrax at 10,000 rpm, followed by stirring for an additional 1 minute. The mixture is further stirred in a propeller stirrer at room temperature under atmospheric pressure to remove the solvent. Hydrochloric acid is added to the reaction mixture to dissolve calcium carbonate. Washing by addition of ion exchanged water followed by filtration is repeated until the conductivity of the filtrate dropped to 2 μS/cm. The filter cake is dried in a vacuum drier and classified using Elbow-Jet classifier to remove fines and coarse particles thereby to obtain cyan toner mother particles 1 with a volume average particle size of 6.4 μm.

### 2. Preparation of Toner Mother Particles 2

Cyan toner mother particles 2 with a volume average particle size of 6.6 μm are prepared in the same manner as in 1, above, except that dispersion A is prepared by stirring 71 parts of amorphous resin (1), 65 parts of amorphous resin (2), 34 parts of the pigment dispersion, 75 parts of the release agent dispersion, and 56 parts of ethyl acetate until uniform.

### 3. Preparation of Carrier 1

The components below are put in a vacuum heating kneader, blended, and dried by heating at 70° C. under reduced pressure. The resulting powder is sieved using a SUS sieve of 200 mesh to obtain carrier 1.

| | |
|---|---|
| Mn—Mg ferrite particles (volume average particle size: | 1000 parts |
| 40 μm) | |
| Styrene/methyl methacrylate copolymer (25/75) resin | 23 parts |
| Carbon black | 2 parts |
| Toluene | 400 parts |

### 4. External Additives

External additive 1: Commercially available rutile titanium dioxide (treated with n-decyltrimethoxysilane; volume average particle size: 20 nm)
External additive 2: Fine silica particles prepared by vapor phase process (treated with dimethylsilicone oil; volume average particle size: 12 nm)

### 5. Preparation of Zinc-Containing Particles

### 5-1. Preparation of Zinc Stearate 1

To 5000 parts of ethanol is added 1145 parts of stearic acid and mixed at 75° C. To the mixture is slowly added 200 parts of zinc hydroxide. After completion of the addition, the mixture is stirred for 1 hour, followed by cooling to 20° C. The product is filtered to be treed of ethanol and any reaction residue and dried in a vacuum heating drier at 150° C. for 3 hours. The dried product is taken out of the drier and allowed to cool to give zinc stearate as a solid mass, which is ground in a jet mill and classified using Elbow Jet air classifier (from Nittetsu Mining Co., Ltd.) to obtain particulate zinc stearate 1 having a number average particle size of 2.6 μm and an average circularity of 0.43.

### 5-2. Preparation of Zinc Stearate 2

Zinc stearate 2 with a number average particle size of 5.2 μm and an average circularity of 0.26 is prepared in the same manner as in 5-1. above, except for adjusting the classification set points of the classifier.

### 5-3. Preparation of Zinc Stearate 3

Zinc stearate 3 with a number average particle size of 1.8 μm and an average circularity of 0.48 is prepared in the same manner as in 5-1. above, except that the grinding in a jet mill is repeated to increase the proportion of fines.

### 5-4. Preparation of Zinc Stearate 4

Zinc stearate 1 prepared above is mixed with an aqueous solution of dodecylbenzenesulfonic acid and pulverized in a homogenizer (15MR-8TA, from APV Gaulin Inc.). The resulting dispersion is filtered, washed, and dried in a vacuum freeze-dryer to obtain zinc stearate 4 having a number average particle size of 2.0 μm and an average circularity of 0.73. Optical microscopic observation reveals that the particles with a smooth shape form a large proportion.

### 5-5. Preparation of Zinc Stearate 5

Zinc stearate 2 prepared above is mixed with an aqueous solution of dodecylbenzenesulfonic acid and pulverized in a homogenizer (15MR-8TA, from APV Gaulin Inc.). The resulting dispersion is filtered, washed, and dried in a vacuum freeze-dryer to obtain zinc stearate 5 having a number average particle size of 4.1 μm and an average circularity of 0.68. Optical microscopic observation revealed that the particles with a smooth shape form a large proportion.

### 6. Preparation of Toner 1 and Developer 1

| | | |
|---|---|---|
| Toner mother particles 1 | 100 | parts |
| External Additive 1 | 1.0 | part |
| External Additive 2 | 2.0 | parts |
| Zinc stearate 1 | 0.3 | parts |

The above components are blended in a Henschel mixer at 3000 rpm for 3 minutes, and the blend is passed through a stainless steel testing sieve (45 μm openings, 200 mm diameter, rom Tokyo Screen Co., Ltd.) to remove coarse grains thereby to give toner 1.

In a twin-cylinder mixer are put 6.0 parts of toner 1 and 100 parts of carrier 1 and stirred at 40 rpm for 20 minutes and then passed through a stainless steel testing sieve (200 mm diameter; 212 μm openings) to give developer 1.

The toner 1 is found to contain 0.41% by number of free zinc-containing particles. The free zinc-containing particles are found to have a number average particle size of 2.4 μm and an average circularity of 0.42.

### 7. Preparation of Toner 2 and Developer 2

Toner 2 and developer 2 are prepared in the same manner as in 6. above, except for replacing zinc stearate 1 with zinc stearate 2.

Toner 2 is found to contain 0.88% by number of free zinc-containing particles. The free zinc-containing particles are found to have a number average particle size of 2.8 μm and an average circularity of 0.33.

### 8. Preparation of Toner 3 and Developer 3

Toner 3 and developer 3 are prepared in the same manner as in 6. above, except for replacing zinc stearate 1 with zinc stearate 3.

Toner 3 is found to contain 0.22% by number of free zinc-containing particles. The free zinc-containing particles are found to have a number average particle size of 1.6 μm and an average circularity of 0.46.

### 9. Preparation of Toner 4 and Developer 4

Toner 4 and developer 4 are prepared in the same manner as in 6. above, except for replacing toner mother particles 1 with toner mother particles 2.

Toner 4 is found to contain 0.39% by number of free zinc-containing particles. The free zinc-containing particles are found to have a number average particle size of 2.4 μm and an average circularity of 0.42.

10. Preparation of Toner 5 and Developer 5

Comparative toner 5 and developer 5 are prepared in the same manner as in 6. above, except for replacing zinc stearate 1 with zinc stearate 4.

Toner 5 is found to contain 0.52% by number of free zinc-containing particles. The free zinc-containing particles are found to have a number average particle size of 2.1 μm and an average circularity of 0.65.

### 11. Preparation of Toner 6 and Developer 6

Toner 6 and developer 6 are prepared in the same manner as in 6 above, except for replacing zinc stearate 1 with zinc stearate 5.

Toner 6 is found to contain 1.11% by number of free zinc-containing particles. The free zinc-containing particles are found to have a number average particle size of 3.4 μm and an average circularity of 0.62.

### 12. Preparation of Toner 7 and Developer 7

Comparative toner 7 and developer 7 are prepared in the same manner as in 11. above, except for replacing toner mother particles 1 with toner mother particles 2.

Toner 7 is found to contain 1.05% by number of free zinc-containing particles. The free zinc-containing particles are found to have a number average particle size of 3.5 μm and an average circularity of 0.62.

### 13. Evaluation

### 13-1 Image Output Test

A multifunctional peripheral device (DocuCentre Color f450, from Fuji Xerox Co., Ltd.) is modified by unloading all the developers provided and, instead, filling the cyan toner cartridge and the developing unit with each of the toners 1 to 7 and each of the corresponding developers 1 to 7, respectively. The thus modified device will be referred to as a testing device.

Printing test is carried out using A4 size paper (C2 Paper, from Fuji Xerox) as paper for output fed in a transverse direction.

The test chart for calibration contained three 1.2 cm wide 17.0 cm long solid images each extending in the output direction at positions 4 cm, 14 cm, and 23 cm away from one longitudinal end of a A4 size paper sheet. The printed image density is measured with a densitometer (X-Rite 938, from X-Rite Inc.) at five points to obtain an average image density. The testing device is adjusted every 1000 prints so that the average image density (ID) might range from 1.25 to 1.55 based on the results of image density measurement.

A condition after storage in high temperature is simulated by placing the testing device containing a developer and a toner to be evaluated in an environment of 55° C. and 85% RH for 10 hours and then at 22° C. and 55% RH for 5 hours. The evaluation test is started with the so conditioned testing device.

### 13-2. Resistance to Filming-Induced Image Quality Defects

Then thousands prints of the test chart are obtained using the conditioned testing device in an environment of 22° C. and 55% RH. The device is then placed in an environment of 30° C. and 60% RH for 5 hours, followed by printing the test chart to obtain 10,000 prints. Thereafter, the device is placed in an environment of 10° C. and 15% RH for 5 hours, followed by printing the test chart to obtain 10,000 prints. Finally, an overall halftone image giving an image density ID of 0.40 to 0.60 is outputted to obtain 10 prints. The tenth print is observed with the naked eye in terms of filming-induced image defects, such as mottle, color streaks, and the like and rated A to C as follows. Only prints rated A are acceptable.
A: Neither blur nor streak occurred.
B: slight blur or streak occurred.
C: Apparent blur or streak occurred.

### 13-3. Low-Temperature Fixing Properties

The conditioned testing device is modified so that the heater of the fixing unit and the temperature measuring unit for control might be externally controlled and is placed in an environment of 22° C. and 55% RH.

The same test chart as used in 13-1. above is printed on A4 size paper (C2 Paper, from Fuji Xerox) fed in a transverse direction using the modified test device.

The printed image density is measured with a densitometer (X-Rite 938, from X-Rite Inc.) at five points to obtain an average image density. The testing device is adjusted so that the average image density (ID) might range from 1.40 to 1.50 based on the results of image density measurement.

The image satisfying the above recited image density is fixed at 110° C., 120° C., 130° C., 140° C., and 150° C. The imaged paper is folded with the image side inside, and a load of 10 g/cm² is applied to the image portion of the folded print for 1 hour. The folded print is unfolded. The image quality along the crease is observed with the naked eye and rated A to C. Only the images rated A are acceptable.
A: No abnormalities other than the streak resulting from the folding is observed.
B: Image cracking is observed.
C: Image cracking is so remarkable as to expose the underlying paper.

The results of evaluation are shown in Table 1.

TABLE 1

| | | Ratio of Free | Average | Average | | | | | | |
|---|---|---|---|---|---|---|---|---|---|---|
| | | Zn-contg. | Particle Size | Circularity | | | | | | |
| | Zn-contg. | Particles in | of Free | of Free | | | | | | |
| | Particles | Toner | Zn-contg. | Zn-contg. | Image | Low Temperature Fixing Properties | | | | |
| | No. | (number %) | Particles (μm) | Particles | Quality | 120° C. | 130° C. | 140° C. | 150° C. | 160° C. |
| Example 1 | 1 | 0.41 | 2.4 | 0.42 | A | A | A | A | A | A |
| Example 2 | 2 | 0.88 | 2.8 | 0.33 | A | A | A | A | A | A |
| Example 3 | 3 | 0.22 | 1.6 | 0.46 | A | A | A | A | A | A |
| Example 4 | 1 | 0.39 | 2.4 | 0.42 | A | B | B | A | A | A |
| Comparative | 4 | 0.52 | 2.1 | 0.65 | B | A | A | A | A | A |
| Example 1 | | | | | | | | | | |
| Comparative | 5 | 1.11 | 3.4 | 0.62 | C | A | A | A | A | A |
| Example 2 | | | | | | | | | | |
| Comparative | 5 | 1.05 | 3.5 | 0.62 | C | C | B | A | A | A |
| Example 3 | | | | | | | | | | |

What is claimed is:

1. An electrostatic image developing toner comprising:
toner mother particles that contain a binder resin, a coloring agent, and a release agent; and
an external additive that contains a zinc-containing particles,
wherein
the number of free zinc-containing particles in all toner particles is from about 0.2% by number to about 1.0% by number, and
the free zinc-containing particles have a number average particle size of from about 1.0 μm to about 3.0 μm and an average circularity of from about 0.2 to about 0.6.

2. The toner according to claim 1, wherein
the zinc-containing particles externally added to the toner mother particles have a number average particle size of about 0 μm to about 5 μm.

3. The toner according to claim 1, wherein
an amount of the zinc-containing particles externally added to the toner mother particles is from about 0.1% by weight to about 0.5% by weight based on the total weight of the toner.

4. The toner according to claim 1, wherein
the zinc-containing particles are zinc stearate particles.

5. The toner according to claim 1, wherein
the binder resin contains a crystalline resin.

6. The toner according to claim 5, wherein
the crystalline resin has a weight average molecular weight of from about 4,000 to about 50,000.

7. The toner according to claim 5, wherein
the crystalline resin has a melting temperature of from about 45° C. to about 110° C.

8. The toner according to claim 1, wherein
the binder resin contains a polyester resin obtained by polymerizing a monomer containing an alkenylsuccinic acid or an anhydride thereof or trimellitic acid or an anhydride thereof.

9. The toner according to claim 1, wherein
the external additive further contains inorganic particles having a primary particle size of from about 5 nm to about 2 μm.

10. The toner according to claim 9, wherein
the inorganic particles contain at least about 85% by weight of SiO₂.

11. The toner according to claim 1, wherein
the release agent has a melting temperature of from about 50° C. to about 110° C.

12. The toner according to claim 1, wherein
a content of the release agent is from about 1 part by weight to about 30 parts by weight per 100 parts by weight of the binder resin.

13. The toner according to claim 1, which has a GSDv of about 1.28 or less.

14. The toner according to claim 1, which has an average circularity of from about 0.940 to about 0.985.

15. An electrostatic image developer comprising:
the toner according to claim 1; and
a carrier.

16. The developer according to claim 15, wherein
the carrier contains a resin and a core material coated with the resin, and
an amount of the coating resin is from about 0.1 part by weight to about 10 parts by weight per 100 parts by weight of the core material.

17. An image forming method comprising:
forming an electrostatic latent image on a surface of an image holding member;
developing the latent image with a developer to form a toner image;
transferring the toner image from the image holding member to a transfer-receiving material; and
fixing the transferred toner image on the transfer-receiving material,
wherein
the developer is the electrostatic image developer according to claim 15.

18. An image forming apparatus comprising:
an image holding member;
a developing unit that develops an electrostatic latent image formed on the image holding member with a developer to form a toner image;
a transfer unit that transfers the toner image to a transfer-receiving material;
a fixing unit that fixes the transferred toner image on the transfer-receiving material; and
a cleaning unit that removes a residual material remaining untransferred on the image holding member,
wherein
the developer is the electrostatic image developer according to claim 15.
